(19) United States
(12) Patent Application Publication
(10) Pub. No.: US 2014/0118417 A1
(43) Pub. Date: May 1, 2014

(54) BACKLIGHT UNIT AND DISPLAY DEVICE

(71) Applicant: LG ELECTRONICS INC., Seoul (KR)

(72) Inventors: Taegu KANG, Pyeongtaek-si (KR); Sangcheon KIM, Pyeongtaek-si (KR)

(73) Assignee: LG ELECTRONICS INC., Seoul (KR)

(21) Appl. No.: 13/975,489

(22) Filed: Aug. 26, 2013

(30) Foreign Application Priority Data
Nov. 1, 2012 (KR) 10-2012-0122967

(51) Int. Cl. G09G 5/10

(52) U.S. Cl. CPC G09G 5/10
USPC 345/690; 315/193; 315/192

(57) ABSTRACT

A backlight unit and a display device including the same are disclosed. The backlight unit includes a substrate and a plurality of light sources disposed on the substrate. The plurality of light sources are divided into a plurality of groups each including at least one light source. The plurality of groups are electrically connected in series with one another. A switching element is electrically connected in parallel with each of the plurality of groups.

This application claims the benefit of Korean Patent Application No. 10-2012-0122967 filed on Nov. 1, 2012, the entire contents of which is incorporated herein by reference for all purposes as if fully set forth herein.

### BACKGROUND OF THE INVENTION

1. Field of the Invention

Embodiments of the invention relate to a backlight unit and a display device.

2. Discussion of the Related Art

With the development of the information society, various demands for display devices have been increasing. Various display devices, such as liquid crystal displays (LCDs), plasma display panels (PDPs), electroluminescent displays (ELDs), and vacuum fluorescent displays (VFDs), have been recently studied and used to meet various demands for the display devices. Among the display devices, a liquid crystal display panel of the liquid crystal display includes a liquid crystal layer, and a thin film transistor (TFT) substrate and a color filter substrate which are positioned opposite each other with the liquid crystal layer interposed therebetween. The liquid crystal display panel displays an image using light provided by a backlight unit of the liquid crystal display.

### SUMMARY OF THE INVENTION

In one aspect, there is a backlight unit comprising a substrate, a plurality of light sources disposed on the substrate, the plurality of light sources being divided into a plurality of groups each including at least one light source, the plurality of groups being electrically connected in series with one another, and a switching element electrically connected in parallel with each of the plurality of groups.

When the number of light sources included in each group is plural, the light sources included in each group are connected in series with one another.

The plurality of groups each include one light source. In this instance, the number of light sources is equal to the number of switching elements.

When at least one switching element is turned on, the light source included in the group corresponding to the turned-on switching element is turned off.

The switching element corresponding to a group of the plurality of groups, of which a voltage between both terminals is greater than a previously determined reference voltage, is turned on.

In another aspect, there is a backlight unit comprising a plurality of substrates, a plurality of light sources disposed on each of the plurality of substrates, the plurality of light sources of each substrate being divided into a plurality of groups each including at least one light source, and a switching element electrically connected in parallel with each of the plurality of groups, wherein the plurality of groups of each substrate are electrically connected in series with one another, wherein the plurality of substrates are electrically connected in parallel with one another.

The plurality of groups each include one light source. In this instance, the number of light sources is equal to the number of switching elements.

When at least one switching element is turned on, the light source included in the group corresponding to the turned-on switching element is turned off.

The switching element corresponding to a group of the plurality of groups, of which a voltage between both terminals is greater than a previously determined reference voltage, is turned on.

In yet another aspect, there is a display device comprising a display panel and a backlight unit positioned in the rear of the display panel, wherein the backlight unit includes a substrate, a plurality of light sources disposed on the substrate, the plurality of light sources being divided into a plurality of groups each including at least one light source, the plurality of groups being electrically connected in series with one another, and a switching element electrically connected in parallel with each of the plurality of groups.

When the number of light sources included in each group is plural, the light sources included in each group are connected in series with one another.

The plurality of groups each include one light source. In this instance, the number of light sources is equal to the number of switching elements.

When a gray level of an image, corresponding to input image data, displayed on a first area of the display panel is lower than a previously determined reference gray level, the light sources included in at least one group corresponding to the first area are turned off. Further, when a gray level of an image, corresponding to input image data, displayed on a second area different from the first area of the display panel is higher than the reference gray level, the light sources included in all of the groups corresponding to the second area are turned on.

When a first group of the plurality of groups corresponds to the first area, a second group different from the first group corresponds to the second area, the first group is connected in parallel with a first switching element, and the second group is connected in parallel with a second switching element, the first switching element is turned on, and the second switching element is turned off.

The switching element corresponding to a group of the plurality of groups, of which a voltage between both terminals is greater than a previously determined reference voltage, is turned on.

The switching element and a resistor are connected in series with an output terminal of a last group of the plurality of groups.

In still yet another aspect, there is a display device comprising a display panel and a backlight unit positioned in the rear of the display panel, wherein the backlight unit includes a first substrate and a second substrate, a plurality of light sources disposed on each of the first substrate and the second substrate, and a switching element electrically connected in parallel with each of the plurality of light sources, wherein the plurality of light sources of each of the first substrate and the second substrate are electrically connected in series with one another, wherein the first substrate and the second substrate are connected in parallel with each other.

The first substrate and the second substrate independently implement a local dimming drive.

When at least one switching element is turned on, the light source corresponding to the turned-on switching element is turned off.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIGS. 1 to 8 illustrate configuration of a display device according to an exemplary embodiment of the invention; and

FIGS. 9 to 27 illustrate a structure and an operation of a backlight unit according to an exemplary embodiment of the invention.

### DETAILED DESCRIPTION OF THE EMBODIMENTS

Reference will now be made in detail embodiments of the invention examples of which are illustrated in the accompanying drawings. Since the present invention may be modified in various ways and may have various forms, specific embodiments are illustrated in the drawings and are described in detail in the present specification. However, it should be understood that the present invention are not limited to specific disclosed embodiments, but include all modifications, equivalents and substitutes included within the spirit and technical scope of the present invention.

The terms ‘first’, ‘second’, etc. may be used to describe various components, but the components are not limited by such terms. The terms are used only for the purpose of distinguishing one component from other components. For example, a first component may be designated as a second component without departing from the scope of the present invention. In the same manner, the second component may be designated as the first component.

The term “and/or” encompasses both combinations of the plurality of related items disclosed and any item from among the plurality of related items disclosed.

When an arbitrary component is described as “being connected to “or” being linked to” another component, this should be understood to mean that still another component(s) may exist between them, although the arbitrary component may be directly connected to, or linked to, the second component. In contrast, when an arbitrary component is described as “being directly connected to” or “being directly linked to” another component, this should be understood to mean that no component exists between them.

The terms used in the present application are used to describe only specific embodiments or examples, and are not intended to limit the present invention. A singular expression can include a plural expression as long as it does not have an apparently different meaning in context.

In the present application, the terms “include” and “have” should be understood to be intended to designate that illustrated features, numbers, steps, operations, components, parts or combinations thereof exist and not to preclude the existence of one or more different features, numbers, steps, operations, components, parts or combinations thereof, or the possibility of the addition thereof.

Unless otherwise specified, all of the terms which are used herein, including the technical or scientific terms, have the same meanings as those that are generally understood by a person having ordinary knowledge in the art to which the present invention pertains. The terms defined in a generally used dictionary must be understood to have meanings identical to those used in the context of a related art, and are not to be construed to have ideal or excessively formal meanings unless they are obviously specified in the present application.

The following exemplary embodiments of the present invention are provided to those skilled in the art in order to describe the present invention more completely. Accordingly, shapes and sizes of elements shown in the drawings may be exaggerated for clarity.

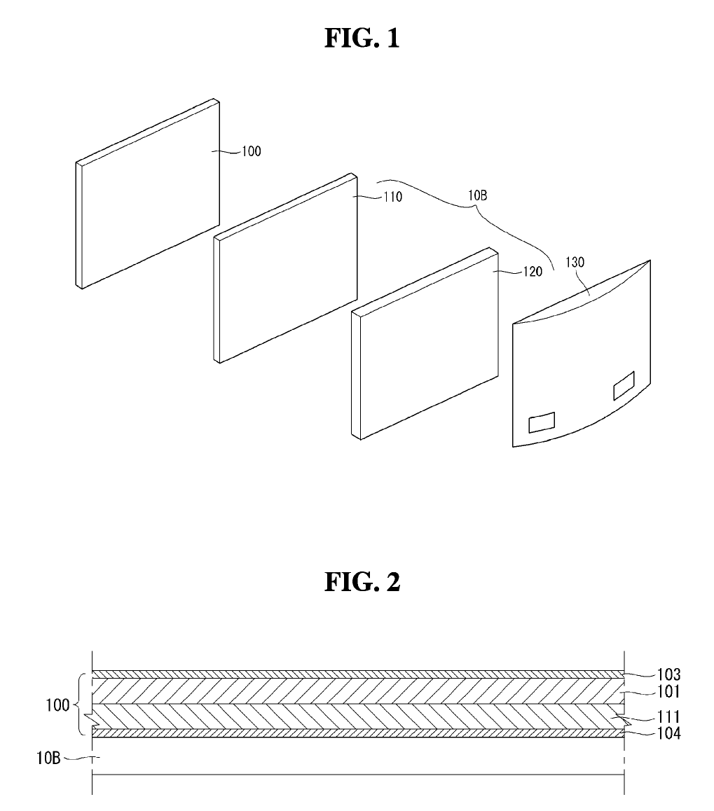

FIGS. 1 to 8 illustrate configuration of a display device according to an exemplary embodiment of the invention.

As shown in FIG. 1, a display device according to an exemplary embodiment of the invention may include a display panel 100, a backlight unit 10B including an optical sheet 110 and a light source part 120, and a back cover 130.

The optical sheet 110 may be positioned between a back substrate of the display panel 100 and the back cover 130

The backlight unit 10B may be disposed in the rear of the display panel 100. Although not shown, the backlight unit 10B may further include a frame as well as the light source part 120.

Various types of light sources may be used in the light source part 120 according to the embodiment of the invention. For example, the light source may be one of a light emitting diode (LED) chip and a LED package having at least one LED chip. In this instance, the light source may be a colored LED emitting at least one of red, green, and blue light or a white LED.

Although the embodiment of the invention describes a direct type backlight unit as an example of the backlight unit 10B, other types of backlight units may be used.

The back cover 130 may be positioned in the rear of the backlight unit 10B.

The back cover 130 may protect the backlight unit 10B and other parts of the display device from an impact or a pressure applied from the outside.

FIG. 2 is a schematic cross-sectional view of the display device according to the embodiment of the invention.

As shown in FIG. 2, the display device may include the display panel 100 and the backlight unit 10B.

The display panel 100 may include a color filter substrate 101 and a thin film transistor (TFT) substrate 111, which are positioned opposite each other and attached to each other to form a uniform cell gap between them. A liquid crystal layer (not shown) may be formed between the color filter substrate 101 and the TFT substrate 111. Hereinafter, the color filter substrate 101 may be referred to as a front substrate, and the TFT substrate 111 may be referred to as a back substrate.

The color filter substrate 101 includes a plurality of pixels each including red (R), green (G), and blue (B) subpixels and may generate a red, green, or blue image when light is applied to the pixels.

In the embodiment of the invention, each of the pixels includes the red, green, and blue subpixels. Other structures may be used for the pixel. For example, each pixel may include red, green, blue, and white (W) subpixels.

The TFT substrate 111 may serve as a switching element and may switch on and off a pixel electrode (not shown).

The liquid crystal layer is comprised of liquid crystal molecules. The arrangement of the liquid crystal molecules may vary depending on a voltage difference between a pixel electrode (not shown) and a common electrode (not shown). Hence, light provided by the backlight unit 10B may be incident on the color filter substrate 101 based on changes in the arrangement of the liquid crystal molecules of the liquid crystal layer.

An upper polarizing plate 103 and a lower polarizing plate 104 may be respectively positioned on an upper surface and a lower surface of the display panel 100. More particularly, the upper polarizing plate 103 may be positioned on an upper surface of the color filter substrate 101, and the lower polarizing plate 104 may be positioned on a lower surface of the TFT substrate 111.

The display device may further include a gate driver (not shown) and a data driver (not shown), each of which generates driving signals for driving the display panel 100.

Since the above-described configuration of the display panel 100 is merely one example, other configurations may be used for the display panel 100.

In the embodiment of the invention, the backlight unit 10B may have the structure in which a plurality of functional layers are sequentially stacked. At least one of the plurality of functional layers may include the light source part 120 including a plurality of light sources.

Further, a bottom cover (not shown), on which the backlight unit 10B is stably placed, may be provided under the backlight unit 10B.

The display panel 100 according to the embodiment of the invention may be divided into a plurality of regions. Brightness (i.e., brightness of the corresponding light source) of light emitted from a region of the backlight unit 10B corresponding to each of the divided regions of the display panel 100 is adjusted based on a gray peak value or a color coordinate signal of each divided region. Hence, a luminance of the display panel 100 may be adjusted.

For this, the backlight unit 10B may be divided into a plurality of division driving regions respectively corresponding to the divided regions of the display panel 100 and may be division-driven. The division drive of the backlight unit 10B will be described in detail below.

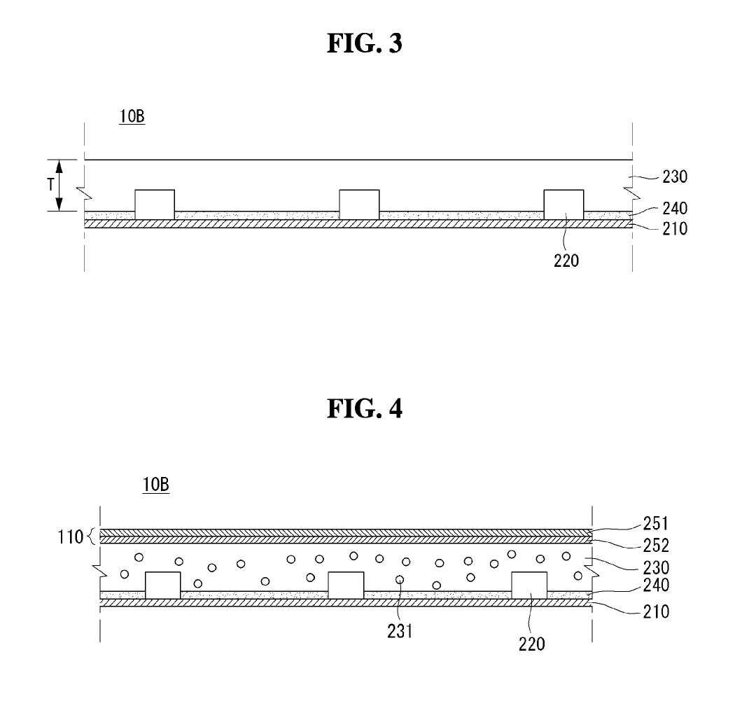

FIG. 3 is a cross-sectional view of the light source part of the backlight unit.

As shown in FIG. 3, the light source part 120 of the backlight unit 10B may include a substrate part 210, a plurality of light sources 220, a resin layer 230, and a reflection layer 240.

The light sources 220 may be formed on the substrate part 210, and the resin layer 230 may be formed on the light sources 220 and the reflection layer 240. Preferably, the resin layer 230 may be formed on the substrate part 210 so as to cover the light sources 220.

Although not shown, the substrate part 210 may include a plurality of substrates. This will be described in detail below. The substrate part 210 may be simply referred to as a substrate.

A connector (not shown) and an electrode pattern (not shown) for connecting the light sources 220 to one another may be formed on the substrate part 210. For example, a carbon nanotube electrode pattern (not shown) for connecting the light sources 220 to the connector may be formed on an upper surface of at least one substrate included in the substrate part 210. The connector may be electrically connected to a power supply unit (not shown) for supplying electric power to the light sources 220.

At least one substrate included in the substrate part 210 may be a printed circuit board (PCB) formed of polyethylene terephthalate (PET), glass, polycarbonate (PC), or silicon. Further, at least one substrate included in the substrate part 210 may be a film substrate.

The light source 220 may be one of a light emitting diode (LED) chip and a LED package having at least one LED chip. In the embodiment of the invention, the LED package is described as an example of the light source 220.

The light source 220 may be configured by a colored LED emitting at least one of red light, green light, blue light, etc. or a white LED emitting white light. In addition, the colored LED may include at least one of a red LED, a blue LED, and a green LED. The disposition and emission light of the light emitting diode may be variously changed within a technical scope of the embodiment.

The resin layer 230 positioned on the substrate part 210 transmits light emitted from the light sources 220, and at the same time diffuses the light emitted from the light sources 220, thereby uniformly providing the light emitted from the light sources 220 to the display panel 100.

The reflection layer 240 may be positioned between the substrate part 210 and the resin layer 230, more particularly on the upper surface of the substrate part 210. The reflection layer 240 may reflect light emitted from the light sources 220.

The reflection layer 240 may again reflect light totally reflected from a boundary between the resin layer 230 and the reflection layer 240, thereby more widely diffusing the light emitted from the light sources 220.

The reflection layer 240 may select a sheet in which a white pigment, for example, titanium dioxide is dispersed, a sheet in which a metal deposition layer is stacked on the surface of the sheet, a sheet in which bubbles are dispersed so as to scatter light, etc. among various types of sheets formed of synthetic resin material. Silver (Ag) may be coated on the surface of the reflection layer 240 so as to increase a reflectance. The reflection layer 240 may be formed by coating a resin on the upper surface of the substrate part 210.

The resin layer 230 may be formed of various kinds of resins capable of transmitting light. For example, the resin layer 230 may contain one or at least two selected from the group consisting of polyethylene terephthalate (PET), polycarbonate (PC), polypropylene, polyethylene, polystyrene, polyepoxy, silicon, acryl, etc.

Further, a refractive index of the resin layer 230 may be approximately 1.4 to 1.6, so that the backlight unit 10B has a uniform luminance by diffusing light emitted from the light sources 220.

The resin layer 230 may contain a polymer resin having an adhesion so as to tightly and closely adhere to the light sources 220 and the reflection layer 240. For example, the resin layer 230 may contain an acrylic resin such as unsaturated polyester, methyl methacrylate, ethyl methacrylate, isobutyl methacrylate, normal butyl methacrylate, normal butylmethylmethacrylate, acrylic acid, methacrylic acid, hydroxy ethylmethacrylate, hydroxy propylmethacrylate, hydroxy ethylacrylate, acrylamide, methylol acrylamide, glycidyl methacrylate, ethylacrylate, isobutylacrlate, normal butylacrylate, 2-ethylhexyl acrylate polymer, copolymer, or terpolymer, etc., an urethane resin, an epoxy resin, a melamine resin, etc.

The resin layer 230 may be formed by coating and curing a liquid or gel-type resin on the upper surface of the substrate part 210 on which the light sources 220 and the reflection layer 240 are formed. Alternatively, the resin layer 230 may be separately manufactured and then may be attached to the upper surface of the substrate part 210.

As a thickness T of the resin layer 230 increases, light emitted from the light sources 220 may be more widely diffused. Hence, the backlight unit 10B may provide light having the uniform luminance to the display panel 100. On the other hand, as the thickness T of the resin layer 230 increases, an amount of light absorbed in the resin layer 230 may increase. Hence, the luminance of light which the backlight unit 10B provides to the display panel 100 may entirely decrease.

Accordingly, the thickness T of the resin layer 230 may be approximately 0.1 mm to 4.5 mm, so that the backlight unit 10B can provide light having the uniform luminance to the display panel 100 without an excessive reduction in the luminance of light.

FIG. 4 is a cross-sectional view showing another configuration of the light source part of the backlight unit according to the embodiment of the invention. In the following description, the descriptions of the configuration and the structure described above are omitted.

As shown in FIG. 4, the plurality of light sources 220 may be disposed on the substrate part 210, and the resin layer 230 may be disposed on the upper surface of the substrate part 210. The resin layer 230 may include a plurality of scattering particles 231. The scattering particles 231 may scatter or refract light incident on the resin layer 230, thereby more widely diffusing light emitted from the light sources 220.

The scattering particles 231 may be formed of a material having a refractive index different from a formation material of the resin layer 230 so as to scatter or refract the light emitted from the light source 220. More particularly, the scattering particles 231 may be formed of a material having a refractive index greater than silicon-based resin or acrylic resin forming the resin layer 230.

For example, the scattering particles 231 may be formed of polymethylmethacrylate (PMMA)/styrene copolymer (MS), polymethylmethacrylate (PMMA), polystyrene (PS), silicon, titanium dioxide (TiO₂), silicon dioxide (SiO₂), or a combination thereof.

Alternatively, the scattering particles 231 may be formed of a material having a refractive index less than the formation material of the resin layer 230. For example, the scattering particles 231 may be formed by generating bubbles in the resin layer 230.

Other materials may be used for the scattering particles 231. For example, the scattering particle 231 may be formed using various polymer materials or inorganic particles.

In the embodiment of the invention, the resin layer 230 may be formed by mixing the liquid or gel-type resin with the scattering particles 231 and then coating and curing a mixture on the upper surface of the substrate part 210 on which the light sources 220 and the reflection layer 240 are formed.

Further, an optical sheet 110 may be disposed on the resin layer 230. For example, the optical sheet 110 may include a prism sheet 251 and a diffusion sheet 252. In this instance, a plurality of sheets constituting the optical sheet 110 are not separated from one another and are attached to one another. Thus, a thickness of the optical sheet 110 or a thickness of the backlight unit 10B may be reduced.

The optical sheet 110 may closely adhere to the resin layer 230.

The diffusion sheet 252 may diffuse incident light to thereby prevent light coming from the resin layer 230 from being partially concentrated. Hence, the diffusion sheet 252 may further uniformize the luminance of light. Further, the prism sheet 251 may focus light coming from the diffusion sheet 252, thereby allowing the light to be vertically incident on the display panel 110.

In the embodiment of the invention, at least one of the prism sheet 251 and the diffusion sheet 252 may be removed in the optical sheet 110. The optical sheet 110 may further include other functional layers in addition to the prism sheet 251 and the diffusion sheet 252.

In a direct light emitting manner of the backlight unit, a LED package constituting the light sources 220 may be classified into a top view type LED package and a side view type LED package based on a direction where a light emitting surface of the LED package faces.

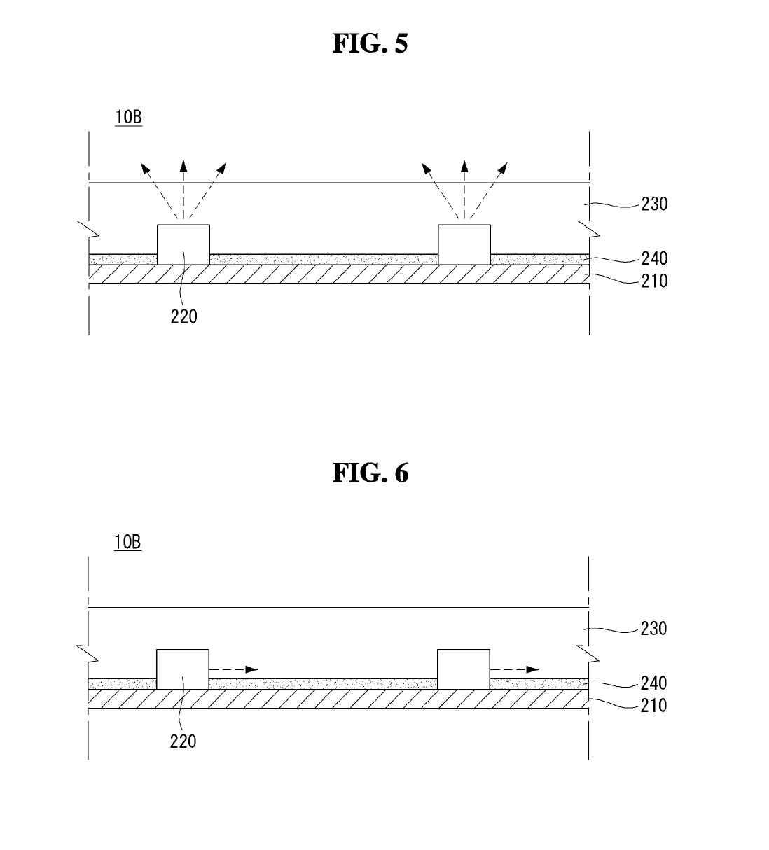

FIG. 5 illustrates a top view type LED package in the direct light emitting manner of the backlight unit.

As shown in FIG. 5, each of the plurality of light sources 220 of the backlight unit 10B has a light emitting surface on an upper surface of each light source 220. Thus, the plurality of light sources 220 may emit light in an upward direction, for example, in a direction perpendicular to the substrate part 210 or the reflection layer 240.

FIG. 6 illustrates a side view type LED package in the direct light emitting manner of the backlight unit.

As shown in FIG. 6, each of the plurality of light sources 220 of the backlight unit 10B has the light emitting surface at the side of each light source 220. Thus, the plurality of light sources 220 may emit light in a lateral direction, for example, a direction parallel to the substrate part 210 or the reflection layer 240. For example, the plurality of light sources 220 may be configured using the side view type LED package. As a result, it is possible to reduce the problem where the light sources 220 are observed as a hot spot on the screen of the display panel 100. Furthermore, the thin profile of the display device may be achieved because of a reduction of the thickness T of the resin layer 230.

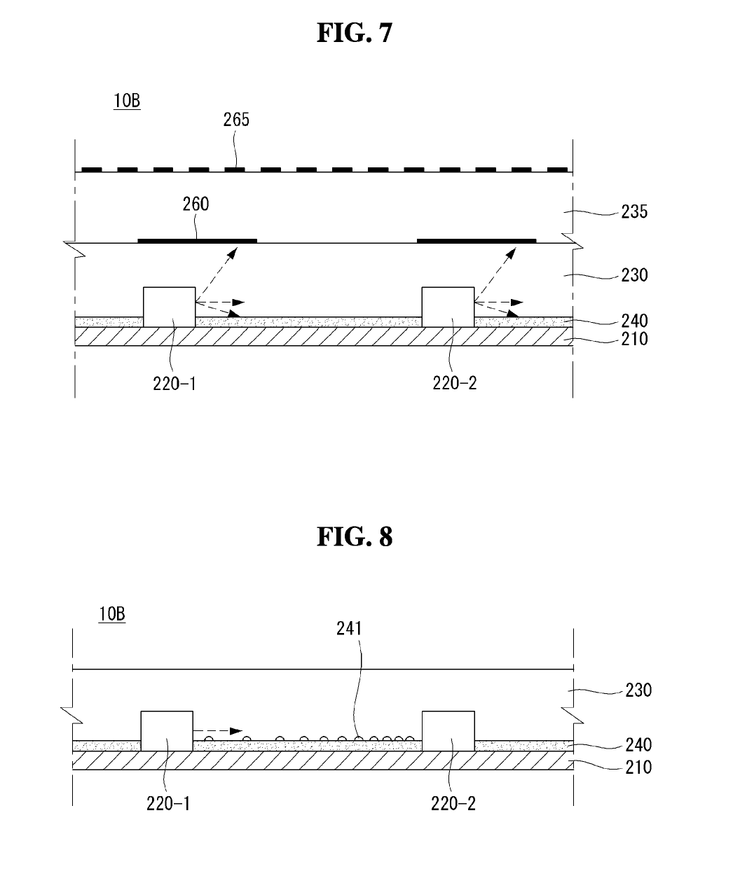

As shown in FIG. 7, the backlight unit 10B may include a plurality of resin layers 230 and 235.

Light emitted from the side of a first light source 220-1 may be transmitted by the first resin layer 230 and may travel to a formation area of a second light source 220-2 adjacent to the first light source 220-1.

A portion of light transmitted by the first resin layer 230 may be emitted in an upward direction corresponding to a direction of the display panel 100. For this, the first resin layer 230 may include a plurality of scattering particles 231 as described above with reference to FIG. 4 and may scatter or refract a direction of the travelling light in the upward direction.

A portion of light emitted from the light source 220 may be incident on the reflection layer 240, and the light incident on the reflection layer 240 may be reflected and diffused in the upward direction.

A large amount of light may be emitted in an area around the light source 220 because of a strong scattering phenomenon around the light source 220 or light emitted from the light source 220 in a direction similar to the upward direction. Hence, light having a high luminance may be observed on the screen of the display panel 100. To prevent this, as shown in FIG. 7, a first light shielding pattern 260 may be formed on the first resin layer 230 to reduce a luminance of light emitted in the area around the light source 220. Hence, the backlight unit 10B may emit light having the uniform luminance. For example, the first light shielding pattern 260 may be formed on the first resin layer 230 corresponding to the formation area of the plurality of light sources 220 to shield a potion of light from the light source 220 and to transmit a portion of the remaining light. Hence, the first light shielding pattern 260 may reduce the luminance of light emitted upward.

The first light shielding pattern 260 may be formed of titanium dioxide (TiO₂). In this instance, the first light shielding pattern 260 may reflect a potion of light from the light source 220 in the downward direction and may transmit a portion of the remaining light.

In the embodiment of the invention, the second resin layer 235 may be disposed on the first resins layer 230. The second resin layer 235 may be formed of the same material as or a material different from the first resins layer 230. The second resin layer 235 may diffuse light emitted from the first resins layer 230 in the upward direction, thereby improving the uniformity of the luminance of light from the backlight unit 10B.

The second resin layer 235 may be formed of a material having a refractive index equal to or different from a refractive index of the formation material of the first resins layer 230.

For example, when the second resin layer 235 is formed of the material having the refractive index greater than the refractive index of the first resins layer 230, the second resin layer 235 may widely diffuse light from the first resin layer 230.

On the contrary, when the second resin layer 235 is formed of the material having the refractive index less than the refractive index of the first resin layer 230, light from the first resin layer 230 may increase a reflectance of light reflected from a lower surface of the second resin layer 235. Hence, light from the light source 220 may easily travel along the first resin layer 230.

Each of the first resin layer 230 and the second resin layer 235 may include a plurality of scattering particles. In this instance, a density of the scattering particles of the second resin layer 235 may be greater than a density of the scattering particles of the first resin layer 230. When the second resin layer 235 includes the scattering particles having the density greater than the first resin layer 230, the second resin layer 235 may widely diffuse light upward emitted from the first resin layer 230. Hence, the uniformity of the luminance of light from the backlight unit 10B may be improved.

As shown in FIG. 7, a second light shielding pattern 265 may be formed on the second resin layer 235 to uniformize the luminance of light from the second resin layer 235. For example, when light upward emitted from the second resin layer 235 is concentrated in a specific potion and thus is observed on the screen as the light having the high luminance, the second light shielding pattern 265 may be formed in an area corresponding to a specific potion of an upper surface of the second resin layer 235. Hence, because the second light shielding pattern 265 may reduce the luminance of light in the specific potion, the luminance of light emitted from the backlight unit 10B may be uniform.

The second light shielding pattern 265 may be formed of titanium dioxide (TiO₂). In this instance, the second light shielding pattern 265 may reflect downward a potion of light from the second resin layer 235 and may transmit a portion of the remaining light.

As shown in FIG. 8, a pattern may be formed on the reflection layer 240, thereby facilitating a travel of light emitted from the first light source 220-1 to the second light source 220-2 adjacent to the first light source 220-1.

The pattern on an upper surface of the reflection layer 240 may include a plurality of protrusions 241. Light, which is emitted from the light source 220 and then is incident on the plurality of protrusions 241, may be scattered or refracted in a direction indicated by an arrow of FIG. 8.

As shown in FIG. 8, a density of the protrusions 241 formed on the reflection layer 240 may increase as a separated distance between the protrusions 241 and the light source 220 increases. Hence, a reduction in a luminance of upward emitted light in an area near to an area distant from the light source 220 may be prevented. As a result, the luminance of light provided by the backlight unit 10B may be uniformly maintained.

The protrusions 241 may be formed of the same material as the reflection layer 240. In this instance, the protrusions 241 may be formed by processing the upper surface of the reflection layer 240.

Alternatively, the protrusions 241 may be formed of a material different from the reflection layer 240. In this instance, the protrusions 241 may be formed by printing the pattern on the upper surface of the reflection layer 240.

The shape of the protrusions 241 is not limited to the shape shown in FIG. 8 and may be variously changed. For example, other shapes such as a prism shape may be used.

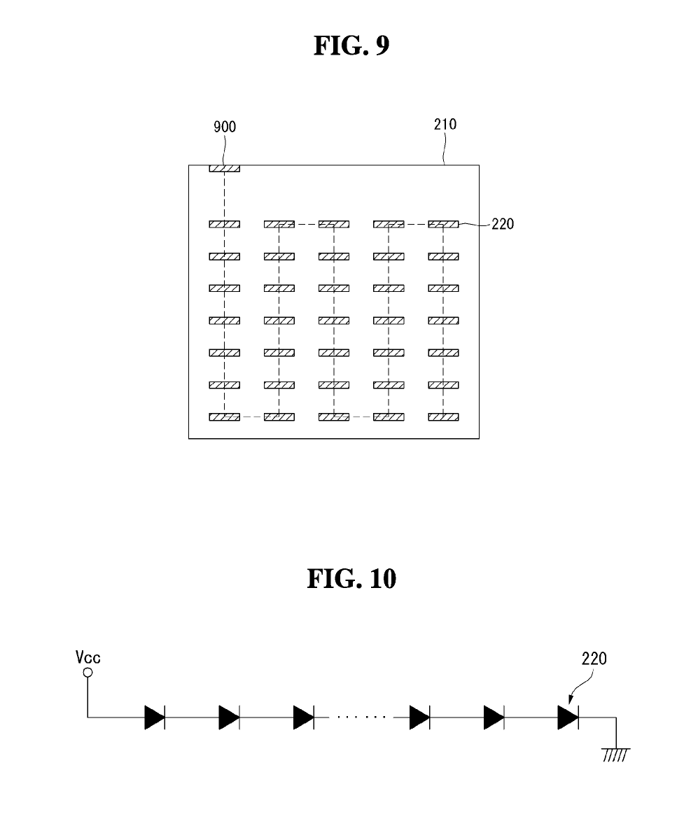

FIGS. 9 to 27 illustrate a structure and an operation of the backlight unit according to the embodiment of the invention. In the following description, the descriptions of the configuration and the structure described above are omitted.

As shown in FIG. 9, the plurality of light sources 220 may be arranged in series on the substrate 210.

An electrode terminal 900 for supplying electric power to the light sources 220 may be formed on the substrate 210.

FIG. 10 is an equivalent circuit diagram of the electrode terminal 900. Hereinafter, the light source 220 is indicated as a diode for the sake of brevity and ease of reading.

The display device according to the embodiment of the invention may implement a local dimming drive using the plurality of light sources 220 which are arranged in series.

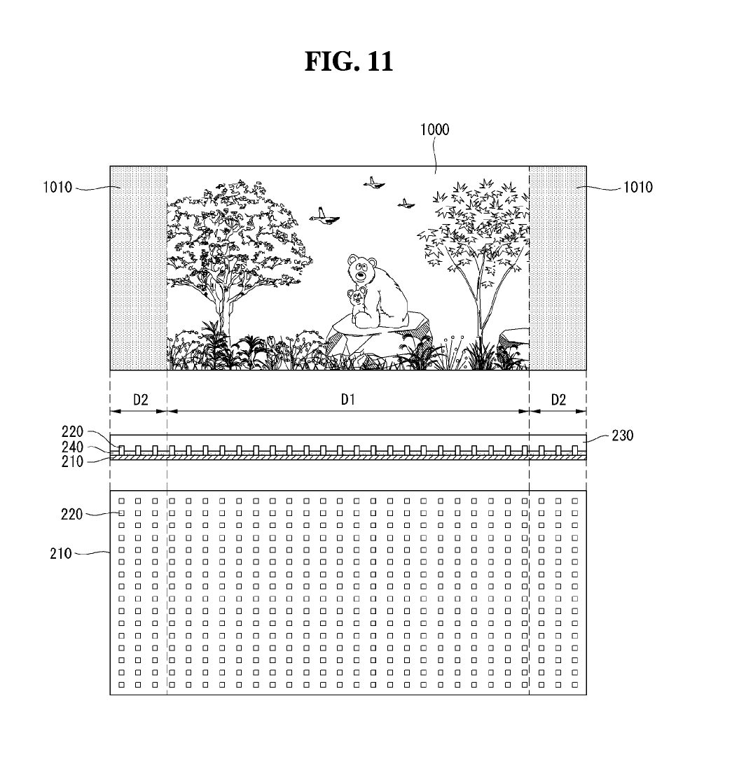

The local dimming drive is described below with reference to FIG. 11.

As shown in FIG. 11, it is assumed that an image of a relatively high gray level is displayed on a first area 1000 of the display panel, and an image of a gray level lower than the image displayed on the first area 1000 is displayed on a second area 1010 of the display panel. Alternatively, any image may not be displayed on the second area 1010.

In this instance, at least one light source 220 disposed at a location corresponding to the second area 1010 may be turned off, and the light sources 220 disposed at a location corresponding to the first area 1000 may be turned on.

Hence, unnecessary power consumption may be reduced, and driving efficiency may be improved.

Alternatively, all of the light sources 220 disposed at the location corresponding to the second area 1010 may be turned off.

In FIG. 11, ‘D1’ denotes the location corresponding to the first area 1000, and ‘D2’ denotes the location corresponding to the second area 1010.

In FIG. 11, an image of a gray level higher than a previously determined reference gray level may be displayed on the first area 1000, and an image of a gray level lower than the reference gray level may be displayed on the second area 1010. In the embodiment of the invention, the reference gray level may be too low for a viewer to perceive, or may be substantially zero.

As described above, the power consumption may be reduced by turning off at least one light source 220 in the area, on which the image lower than the reference gray level is displayed or any image is not displayed. The driving method may be referred to as the local dimming drive.

It may be preferable, but not required, that a switching element, is disposed in parallel with at least one light source so as to implement the local dimming drive depending on input image data.

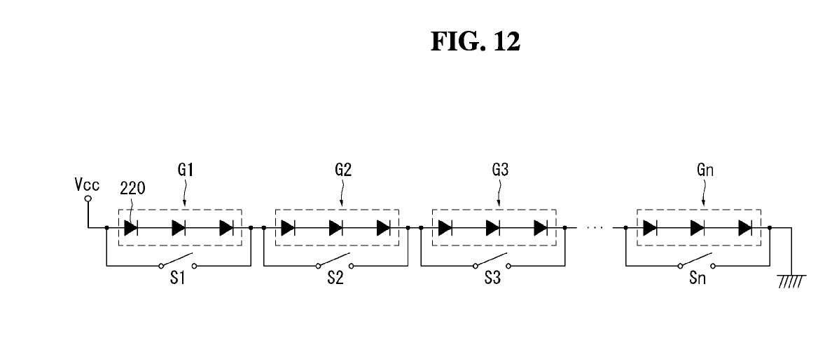

For example, as shown in FIG. 12, a first switching element S1 may be disposed in parallel with a first group G1 including the three successively arranged light sources 220; a second switching element S2 may be disposed in parallel with a second group G2 including the three successively arranged light sources 220; and a third switching element S3 may be disposed in parallel with a third group G3 including the three successively arranged light sources 220. Thus, an nth switching element Sn may be disposed in parallel with an nth group Gn including the three successively arranged light sources 220.

One group may be considered as a unit light source block for the local dimming drive. Namely, the plurality of light sources may be turned on or off on a per group basis in the local dimming drive.

FIG. 12 shows that one group includes the three light sources. The embodiment of the invention is not limited thereto.

For example, one group may include the ten light sources, or each light source 220 may configure one group. Alternatively, the number of light sources 220 included in at least one group may be different from the number of light sources 220 included in other group.

To turn off at least one group in the local dimming drive, a switching element connected in parallel with the at least one group may be turned on.

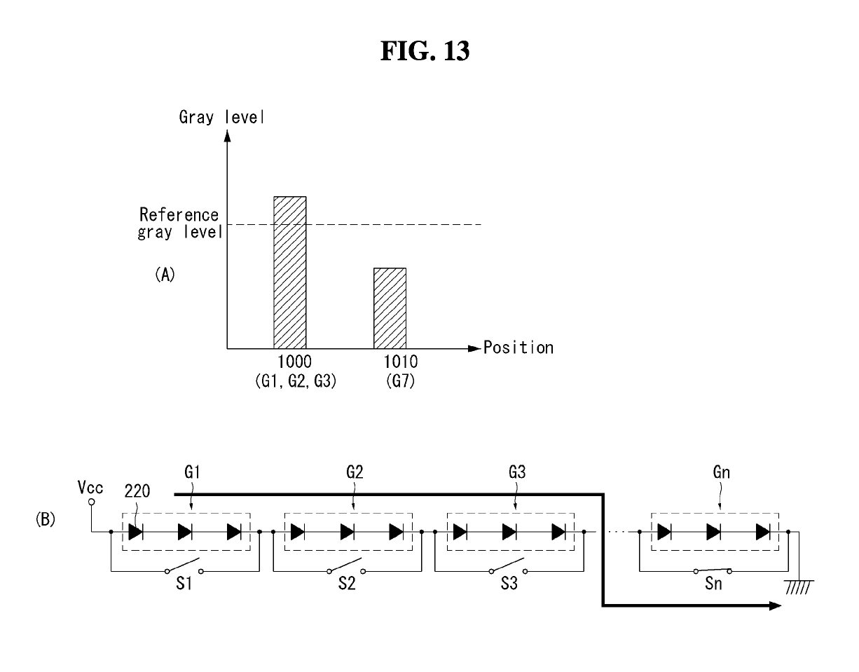

As shown in (A) of FIG. 13, it is assumed that gray levels of areas of the display panel corresponding to first, second, and third groups G1, G2, and G3 are lower than a previously determined reference gray level, and a gray level of an area of the display panel corresponding to an nth group Gn is higher than the reference gray level.

For example, the first area 1000 shown in FIG. 11 may correspond to the first, second, and third groups G1, G2, and G3, and the second area 1010 may correspond to the nth group Gn.

In this instance, as shown in (B) of FIG. 13, first, second, and third switching elements S1, S2, and S3 may be turned off so as to turn on the first, second, and third groups G1, G2, and G3. Then, electric power Vcc is supplied to the first, second, and third groups G1, G2, and G3, and thus the first, second, and third groups G1, G2, and G3 may be turned on.

On the other hand, an nth switching element Sn may be turned on so as to turn off the nth group Gn. Then, the electric power Vcc flows through the nth switching element Sn and is discharged. Namely, because the supply of the electric power Vcc to the nth group Gn is blocked, the nth group Gn may be turned off.

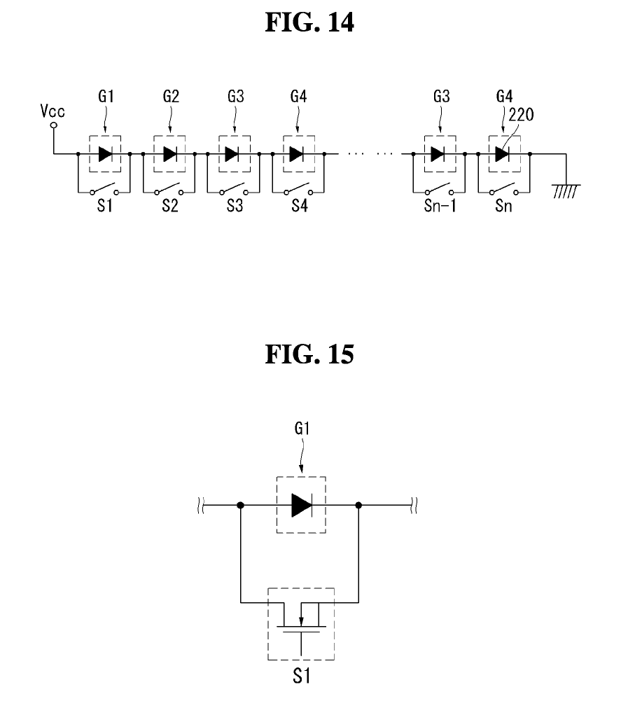

So far, the embodiment of the invention described and showed that each group includes the three light sources. However, as shown in FIG. 14, each group may include only one light source. Namely, each light source 220 may configure one group.

In this instance, a switching element may be connected in parallel with each light source 220. Thus, the number of light sources 220 may be equal to the number of switching elements.

As described above, when the switching element is connected in parallel with each light source 220, the light sources 220 may be independently driven. Hence, the driving efficiency may be further improved, and an effect of the local dimming drive may be further improved.

The switching element connected in parallel with the light source 220 may be implemented as a transistor, for example, a field-effect transistor (FET).

For example, as shown in FIG. 15, a first switching element S1 and a first group G1 including one light source 220 may be connected in parallel with each other in such a manner that a source terminal of the first switching element S1 is connected to a cathode terminal of the first group G1 and a drain terminal of the first switching element S1 is connected to an anode terminal of the first group G1.

The embodiment of the invention used an N-channel FET as an example of the switching element. However, other transistors may be used. For example, a P-channel FET and a bipolar junction transistor (BJT) may be used.

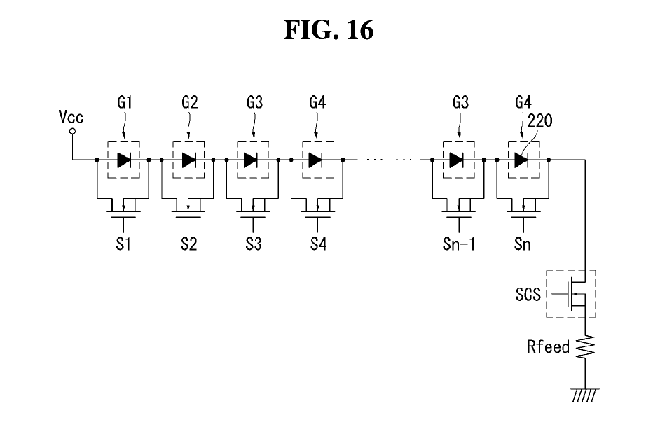

As shown in FIG. 16, when the FET is used as the switching element as described above, a switching control switching element SCS may be disposed at an output terminal (i.e., a cathode terminal) of a last group so as to effectively perform turn-on and turn-off operations of the switching element.

A feedback resistor Rfeed may be disposed so as to sense a current flowing in the switching control switching element SCS. Preferably, the feedback resistor Rfeed may be disposed between the switching control switching element SCS and the ground.

The current flowing in the switching control switching element SCS may be sensed by sensing a current flowing in the feedback resistor Rfeed. Turn-on and turn-off operations of the switching control switching element SCS may be controlled using the current flowing in the feedback resistor Rfeed.

For example, when the current flowing in the switching control switching element SCS excessively increases to a value equal to or greater than a previously determined reference value, the switching control switching element SCS may be turned off.

Unlike the embodiment of the invention, groups each including at least one light source 220 may be connected in parallel with one another.

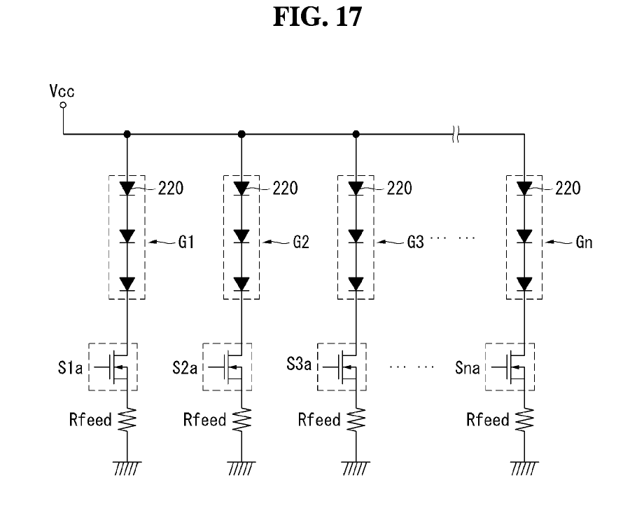

As shown in FIG. 17, groups G1 to Gn each including three light sources 220 may be connected in parallel with one another.

In this instance, local dimming switching elements S1a to Sna need to be respectively connected in series with output terminals of the groups G1 to Gn so as to perform the local dimming drive of each of the groups G1 to Gn.

Further, a feedback resistor Rfeed may be disposed between each of the local dimming switching elements S1a to Sna and the ground.

For example, the first group G1, the first local dimming switching element S1a, and the feedback resistor Rfeed may be disposed in series between a power source Vcc and the ground. Further, the second group G2, the second local dimming switching element S2a, and the feedback resistor Rfeed may be disposed in series between the power source Vcc and the ground and may be disposed in parallel with the first group G1.

The power supply of each of the groups G1 to Gn may be controlled by turning on or off the local dimming switching elements S1a to Sna.

In this instance, the power consumption may increase.

For example, in the configuration shown in FIG. 17, electric power consumed by a total of the n feedback resistors Rfeed and electric power consumed by a total of the n local dimming switching elements S1a to Sna may be considered as a loss as indicated by the following Equation (1).

nRds(Iled)²+nRfeed(Iled)² (1)

where “Rds” is an on-resistance of the local dimming switching elements S1a to Sna, and “Iled” is a string current of the light source 220.

Furthermore, in the configuration shown in FIG. 17, because voltage characteristics of the plurality of groups are different from one another, the electric power Vcc has to be set based on the group having the maximum voltage characteristic.

For example, supposing that a forward voltage Vf of a first group G1 and a forward voltage Vf of a second group G2 are 10V and 12V, respectively, it may be preferable, but not required, the electric power of at least 12V is supplied to the first group G1 and the second group G2. However, in this instance, the first group G1 may unnecessarily consume the voltage of 2V.

Accordingly, when the plurality of groups are disposed in parallel, the power consumption may further increase due to a difference between the voltage characteristic of each group and the electric power Vcc supplied to each group.

On the other hand, because the configuration shown in FIG. 16 is possible to use only one switching control switching element SCS and one feedback resistor Rfeed, the configuration shown in FIG. 16 may reduce the power consumption compared to the configuration shown in FIG. 17.

For example, in the configuration shown in FIG. 16, electric power consumed by one switching control switching element SCS and electric power consumed by one feedback resistor Rfeed may be considered as a loss as indicated by the following Equation (2).

Rds(Iled)²+Rfeed(Iled)² (2)

where “Rds” is an on-resistance of the switching control switching element SCS, and “Iled” is a string current of the light source 220.

When comparing Equation (1) and Equation (2), the electric power unnecessarily consumed in the configuration shown in FIG. 16 may be reduced to 1/n compared to that in the configuration shown in FIG. 17.

Furthermore, because the plurality of groups are disposed in series in the configuration shown in FIG. 16, the power consumption resulting from a difference between the voltage characteristic of each group and the electric power Vcc supplied to each group may be reduced.

When the plurality of groups are disposed in parallel, a process for generating the power voltage Vcc may be further complicated.

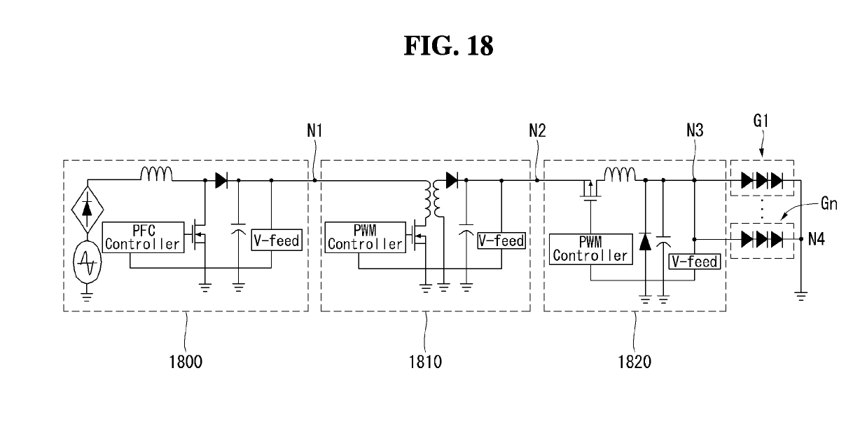

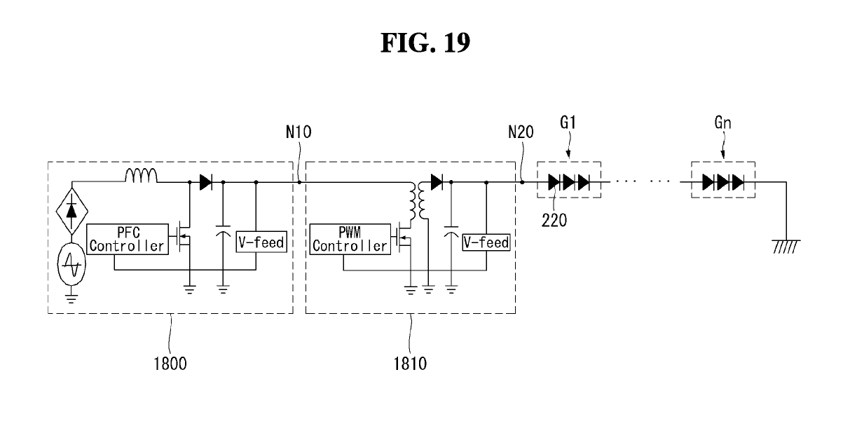

For example, as shown in FIG. 18, when commercial AC power is input, a power factor improvement circuit 1800 may output a DC voltage of about 400 V. Examples of the power factor improvement circuit 1800 may include a boost converter. In FIG. 18, an output terminal of the power factor improvement circuit 1800 is a first node N1.

The voltage output from the power factor improvement circuit 1800 may be converted into a DC voltage of about 24 V through a switch mode power supply (SMPS) 1810. In FIG. 18, an output terminal of the SMPS 1810 is a second node N2.

Afterward, an output voltage of the SMPS 1810 may be converted into a DC voltage of about 9.6V through a DC converter 1820. Examples of the DC converter 1820 may include a buck converter. In FIG. 18, an output terminal of the DC converter 1820 is a third node N3. In the embodiment of the invention, the voltage of the third node N3 may be the power voltage Vcc supplied to the plurality of groups.

As described above, when the plurality of groups are disposed in parallel, a total of three processes for supplying the power voltage Vcc to the groups may be performed.

On the other hand, when the plurality of groups are disposed in series, a process for converting the power voltage Vcc may be simplified.

For example, as shown in FIG. 19, when the commercial AC power is input, the power factor improvement circuit 1800 may output a DC voltage of about 400V. In FIG. 19, an output terminal of the power factor improvement circuit 1800 is a ninth node N10.

The voltage output from the power factor improvement circuit 1800 may be converted into a DC voltage of about 24V through the SMPS 1810. In FIG. 19, an output terminal of the SMPS 1810 is a twentieth node N20.

The plurality of groups disposed in series may be driven using an output voltage of the SMPS 1810.

Namely, when the plurality of groups are disposed in series, the number of light sources positioned on one string increases. Therefore, the power voltage Vcc supplied to the one string may increase.

As described above, when the plurality of groups are disposed in series, the process for converting the power voltage Vcc may be simplified. Hence, the power consumption may be further reduced.

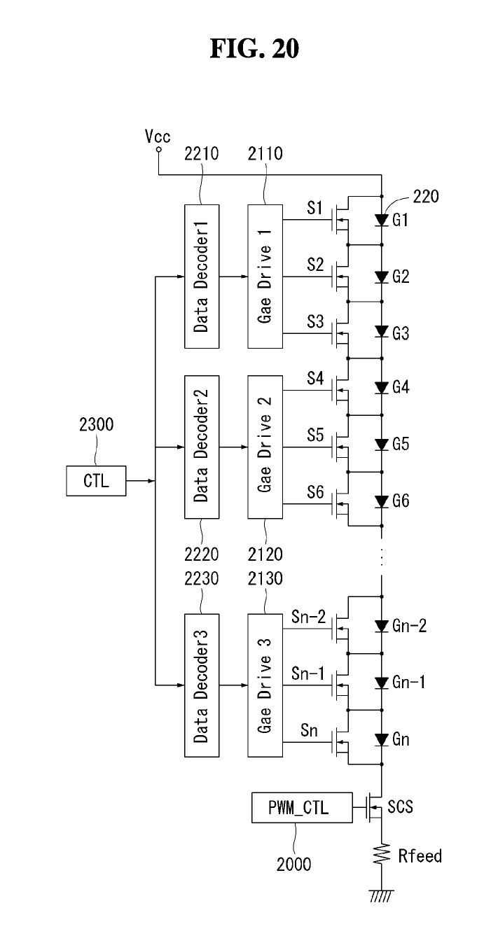

FIG. 20 illustrates the configuration of the display device when the plurality of groups are disposed in series.

As shown in FIG. 20, a gate driver may be connected to gate terminals of switching elements S1 to Sn, each of which is disposed in parallel with each group. For example, a first gate driver 2110 (or ‘Gate Driver 1’) may be connected to gate terminals of first, second, and third switching elements S1, S2, and S3; a second gate driver 2120 (or ‘Gate Driver 2’) may be connected to gate terminals of fourth, fifth, and sixth switching elements S4, S5, and S6; and a third gate driver 2130 (or ‘Gate Driver 3’) may be connected to gate terminals of (n−2)th, (n−1)th, and nth switching elements Sn−2, Sn−1, and Sn.

FIG. 20 illustrates that each gate driver corresponds to the three switching elements. However, the three switching elements connected to each gate driver may be independently driven. For example, the first and second switching elements S1 and S2 connected to the first gate driver 2110 may be independently turned on or off.

In FIG. 20, because the gate driver may be manufactured in the form of a module or a chip, the plurality of switching elements may be connected to one gate driver. Namely, FIG. 20 illustrates that one gate driver is connected to the three switching elements.

The number of switching elements connected to one gate driver may be variously changed.

Alternatively, unlike FIG. 20, one switching element may be connected to one gate driver.

In such a configuration, a controller 2300 (or ‘CTL’) may calculate a gray level of input image data. Further, the controller 2300 may output a control signal for adjusting a luminance of the light source depending on the calculated gray level. The control signal may be referred to as a local dimming signal.

The local dimming signal may be transferred in a type of serial data.

The local dimming signal output by the controller 2300 may be input to data decoders 2210 to 2230 (or ‘Data Decoder 1’ to ‘Data Decoder 3’).

The data decoders 2210 to 2230 may decode the local dimming signal of the serial data type.

The data decoders 2210 to 2230 may output the control signal depending on the decoded local dimming signal.

Accordingly, the gate drivers 2110 to 2130 may output a control signal for turning on and off the switching elements depending on the control signal output by the data decoders 2210 to 2230.

The display device according to the embodiment of the invention may further include a pulse width modulation (PWM) controller 2000 for controlling turn-on and turn-off operations of the switching control switching element SCS.

FIG. 20 shows that the PWM controller 2000 is configured separately from the controller 2300. However, the PWM controller 2000 may be included in the controller 2300.

When at least one group of the plurality of groups is damaged and opened, it may be preferable, but not required, that the switching element connected in parallel with the open group is maintained in a turn-on state.

For this, it may be decided whether or not the open group is present among the plurality of groups. More specifically, it may be decided whether or not a light source is opened by detecting voltages of a drain terminal and a source terminal of the light source.

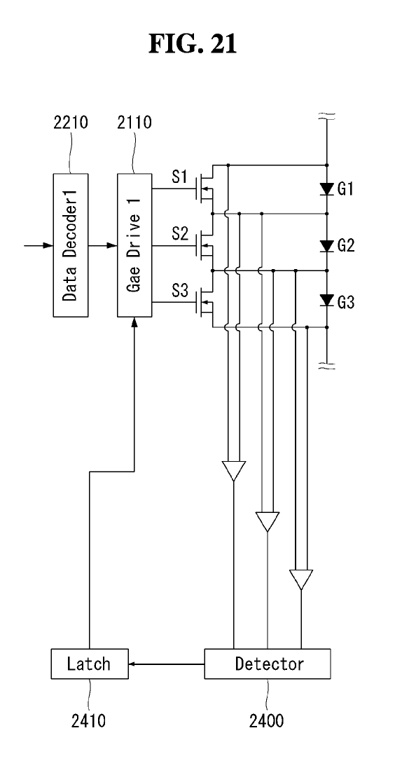

For this, as shown in FIG. 21, the display device according to the embodiment of the invention may further include a detector 2400 for detecting a voltage between an input terminal and an output terminal of each group.

The detector 2400 may compare voltages of a drain terminal and a source terminal of, for example, a first group G1 and detect a voltage between the drain terminal and the source terminal of the first group G1.

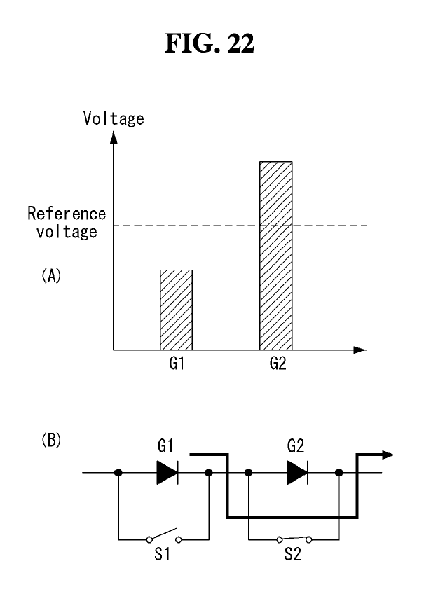

As shown in (A) of FIG. 22, if a voltage between a drain terminal and a source terminal of a first group G1 is less than a previously determined reference voltage and a voltage between a drain terminal and a source terminal of a second group G2 is greater than the reference voltage, it may be decided that the second group G2 is opened.

If the second group G2 is damaged and opened, a current may not flow in the light source(s) belonging to the second group G2. Hence, the voltage between the drain terminal and the source terminal of the second group G2 may abnormally increase.

In this instance, a latch unit 2410 shown in FIG. 21 may supply a control signal, which cuts off the supply of the current to the second group G2, to the first gate driver 2110.

As a result, as shown in (B) of FIG. 22, a second switching element S2 connected in parallel with the second group G2 may be maintained in a turn-on state.

In the embodiment of the invention, the substrate 210 of the backlight unit may be divided into a plurality of parts. The division of the substrate 210 may be a physical division.

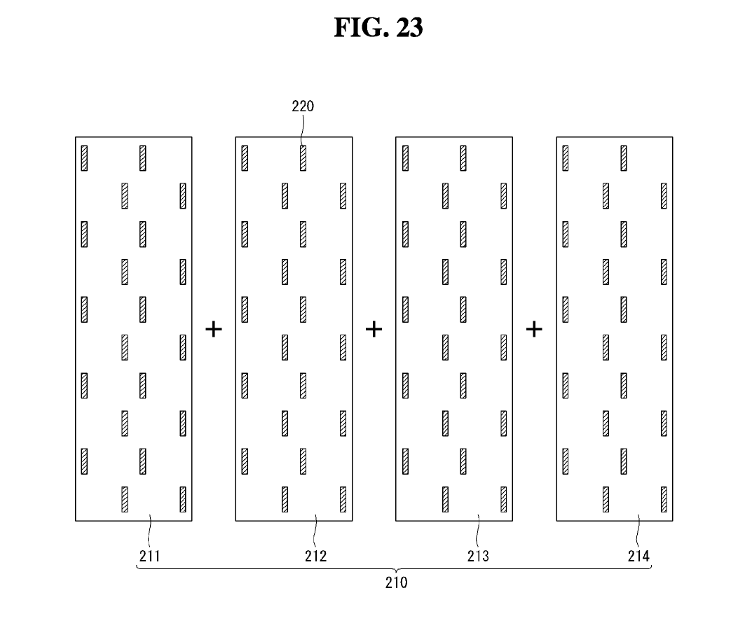

For example, as shown in of FIG. 23, the backlight unit according to the embodiment of the invention may include a plurality of substrates 211 to 214. FIG. 23 shows the backlight unit including the four substrates 211 to 214. The number of substrates included in the backlight unit is not limited in the embodiment of the invention.

As shown in of FIG. 23, the backlight unit according to the embodiment of the invention may include the first to fourth substrates 211 to 214. The first to fourth substrates 211 to 214 may be referred to as sub-substrates. Namely, the plurality of sub-substrates 211 to 214 may form a mother substrate.

In this instance, the plurality of light sources 220 may be disposed on each of the first to fourth substrates 211 to 214, and then the first to fourth substrates 211 to 214, on which the light sources 220 are disposed, may be combined with one another in a line. Hence, a mother substrate 210 may be formed.

In the embodiment of the invention, if a damage is generated in the mother substrate 210 which is divided into the plurality of substrates 211 to 214, only a damaged portion (i.e., only the damaged substrate) of the mother substrate 210 may be replaced, and the remaining normal substrates may be continuously used. Hence, the material consumed by the damage of the substrate 210 may be reduced. As a result, the manufacturing cost may be reduced.

As described above, when the mother substrate 210 is divided into the plurality of substrates 211 to 214, a connector (not shown) may be disposed on each of the plurality of substrates 211 to 214.

The connector may be electrically connected to at least one light source 220 disposed on each of the substrates 211 to 214. Although not shown, the connector may electrically connect an external driving circuit to the light source 220, thereby causing a driving voltage supplied by the driving circuit to be supplied to the light source 220.

As described above, when the mother substrate 210 is divided into the plurality of substrates 211 to 214, after the plurality of substrates 211 to 214 are disposed parallel to one another, the reflection layer 240 may be disposed on the plurality of substrates 211 to 214.

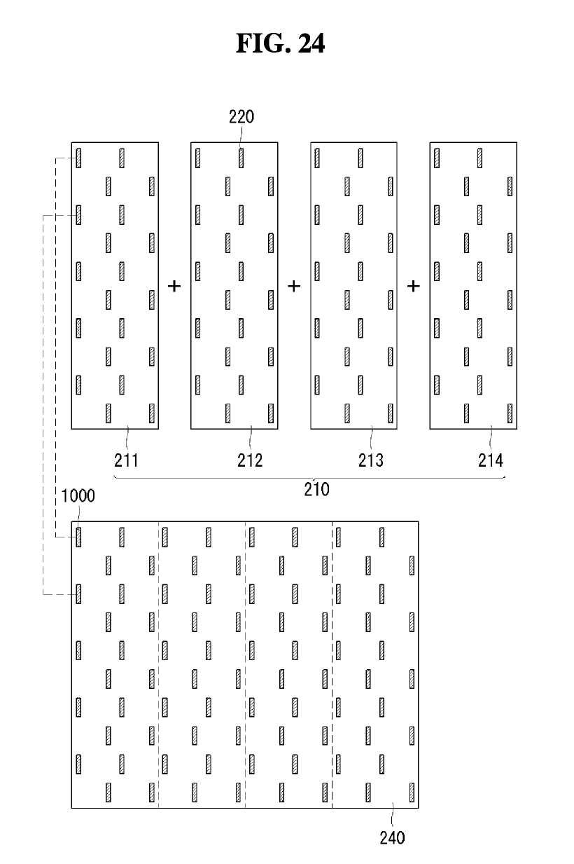

For example, as shown in FIG. 24, the first to fourth substrates 211 to 214 are disposed parallel to one another, and a sheet type reflection layer 240 having a plurality of holes 1000 may be disposed on the first to fourth substrates 211 to 214.

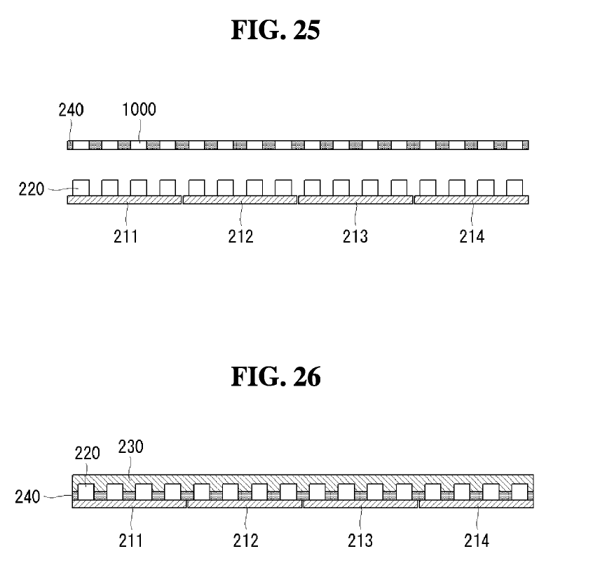

More specifically, as shown in FIG. 25, the reflection layer 240 may be disposed on the first to fourth substrates 211 to 214, so that the plurality of light sources 220 on the first to fourth substrates 211 to 214 are aligned with the plurality of holes 1000 of the reflection layer 240. The reflection layer 240 may be formed of a material having a high reflectance, for example, silver (Ag). For example, the reflection layer 240 may be a foil formed of silver (Ag).

In this instance, the reflection layer 240 may commonly overlap at least two substrates. For example, as shown in FIG. 25, one sheet type reflection layer 240 may be disposed on the four substrates 211 to 214.

In this instance, a process for forming the reflection layer 240 may be simplified. Further, because the integrated reflection layer 240 is formed on the first to fourth substrates 211 to 214, reflection efficiency may be improved. Because the planarization of the reflection layer 240 is maintained even at boundaries of the substrates 211 to 214, the reflection efficiency may be further improved.

Although not shown, before the reflection layer 240 is formed on the substrates 211 to 214, an adhesive layer may be formed on the substrates 211 to 214. Hence, an adhesive strength between the reflection layer 240 and the substrates 211 to 214 may be improved, and also an adhesive strength between the substrates 211 to 214 may be improved.

Next, as shown in FIG. 26, the resin layer 230 may be formed on the light sources 220 and the reflection layer 240.

The resin layer 230 may be formed by applying a resin material to the mother substrate 210, on which the light sources 220 and the reflection layer 240 are formed, and drying the applied resin material.

Alternatively, the reflection layer 240 may be divided into a plurality of parts.

As described above, when the mother substrate 210 is divided into the plurality of substrates 211 to 214, the plurality of groups disposed on each of the plurality of substrates 211 to 214 may be disposed in series.

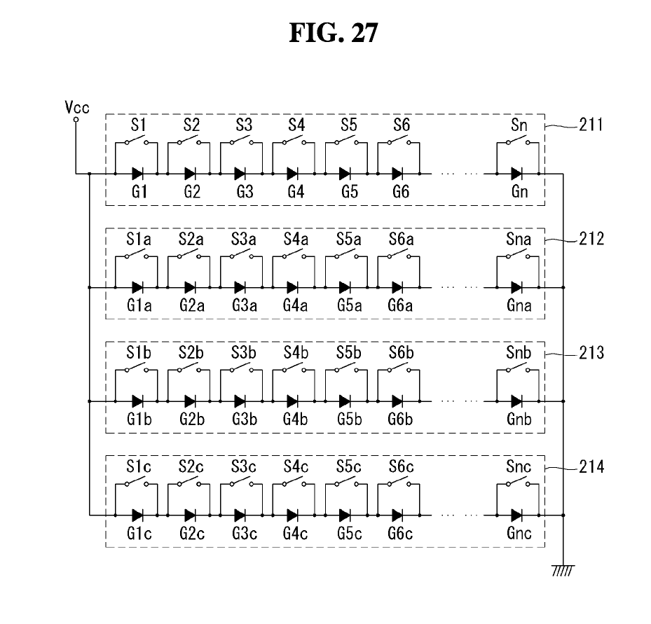

For example, as shown in FIG. 27, a plurality of groups each including one light source 220 may be disposed in series on each of the plurality of substrates 211 to 214, and a switching element may be connected in parallel with each of the plurality of groups.

The plurality of substrates 211 to 214 may be connected in parallel with one another.

It may be preferable, but not required, that each of the plurality of substrates 211 to 214, which are physically divided from the mother substrate 210, is connected to the power source. Hence, the plurality of substrates 211 to 214 may be disposed parallel to one another.

Further, the plurality of substrates 211 to 214 may be independently driven in the local dimming manner.

For example, it is assumed that the display panel includes a first screen area corresponding to the first substrate 211 and a second screen area corresponding to the second substrate 212.

In this instance, when a gray level of an image corresponding to input image data displayed on a first portion of the first screen area is lower than a previously determined reference gray level, at least one light source corresponding to the first portion may be turned off. Further, when a gray level of an image corresponding to input image data displayed on a second portion of the second screen area is higher than the reference gray level, all of the light sources corresponding to the second portion may be turned on.

Namely, the first substrate 211 and the second substrate 212 may be independently driven in the local dimming manner.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A backlight unit comprising:
a substrate;
a plurality of light sources disposed on the substrate, the plurality of light sources being divided into a plurality of groups each including at least one light source, the plurality of groups being electrically connected in series with one another; and
a switching element electrically connected in parallel with each of the plurality of groups.

2. The backlight unit of claim 1, wherein when the number of light sources included in each group is plural, the light sources included in each group are connected in series with one another.

3. The backlight unit of claim 1, wherein the plurality of groups each include one light source.

4. The backlight unit of claim 3, wherein the number of light sources is equal to the number of switching elements.

5. The backlight unit of claim 1, wherein when at least one switching element is turned on, the light source included in the group corresponding to the turned-on switching element is turned off.

6. The backlight unit of claim 1, wherein the switching element corresponding to a group of the plurality of groups, of which a voltage between both terminals is greater than a previously determined reference voltage, is turned on.

7. A backlight unit comprising:
a plurality of substrates;
a plurality of light sources disposed on each of the plurality of substrates, the plurality of light sources of each substrate being divided into a plurality of groups each including at least one light source; and
a switching element electrically connected in parallel with each of the plurality of groups,
wherein the plurality of groups of each substrate are electrically connected in series with one another,
wherein the plurality of substrates are electrically connected in parallel with one another.

8. The backlight unit of claim 7, wherein the plurality of groups each include one light source,
wherein the number of light sources is equal to the number of switching elements.

9. The backlight unit of claim 7, wherein when at least one switching element is turned on, the light source included in the group corresponding to the turned-on switching element is turned off.

10. The backlight unit of claim 7, wherein the switching element corresponding to a group of the plurality of groups, of which a voltage between both terminals is greater than a previously determined reference voltage, is turned on.

11. A display device comprising:
a display panel; and
a backlight unit positioned in the rear of the display panel,
wherein the backlight unit includes:
a substrate;
a plurality of light sources disposed on the substrate, the plurality of light sources being divided into a plurality of groups each including at least one light source, the plurality of groups being electrically connected in series with one another; and
a switching element electrically connected in parallel with each of the plurality of groups.

12. The display device of claim 11, wherein when the number of light sources included in each group is plural, the light sources included in each group are connected in series with one another.

13. The display device of claim 11, wherein the plurality of groups each include one light source,
wherein the number of light sources is equal to the number of switching elements.

14. The display device of claim 11, wherein when a gray level of an image, corresponding to input image data, displayed on a first area of the display panel is lower than a previously determined reference gray level, the light sources included in at least one group corresponding to the first area are turned off,
wherein when a gray level of an image, corresponding to input image data, displayed on a second area different from the first area of the display panel is higher than the reference gray level, the light sources included in all of the groups corresponding to the second area are turned on.

15. The display device of claim 14, wherein when a first group of the plurality of groups corresponds to the first area, a second group different from the first group corresponds to the second area, the first group is connected in parallel with a first switching element, and the second group is connected in parallel with a second switching element, the first switching element is turned on, and the second switching element is turned off.

16. The display device of claim 14, wherein the switching element corresponding to a group of the plurality of groups, of which a voltage between both terminals is greater than a previously determined reference voltage, is turned on.

17. The display device of claim 11, wherein the switching element and a resistor are connected in series with an output terminal of a last group of the plurality of groups.

18. A display device comprising:
a display panel; and
a backlight unit positioned in the rear of the display panel,
wherein the backlight unit includes:
a first substrate and a second substrate;
a plurality of light sources disposed on each of the first substrate and the second substrate; and
a switching element electrically connected in parallel with each of the plurality of light sources,
wherein the plurality of light sources of each of the first substrate and the second substrate are electrically connected in series with one another,
wherein the first substrate and the second substrate are connected in parallel with each other.

19. The display device of claim 18, wherein the first substrate and the second substrate independently implement a local dimming drive.

20. The display device of claim 18, wherein when at least one switching element is turned on, the light source corresponding to the turned-on switching element is turned off.
